(19) United States
(12) Patent Application Publication
(10) Pub. No.: US 2026/0042359 A1
(43) Pub. Date: Feb. 12, 2026

(54) HYBRID ELECTRIC SYSTEM AND DRIVE MECHANISM AND RANGE EXTENDER THEREOF, AND VEHICLE INCLUDING SAME

(71) Applicant: ZF Friedrichshafen AG, Friedrichshafen (DE)

(72) Inventors: Qing Xu, Shanghai (CN); Shaozhi Yuan, Shanghai (CN); Lei Song, Shanghai (CN)

(73) Assignee: ZF Friedrichshafen AG, Friedrichshafen (DE)

(21) Appl. No.: 19/293,676

(22) Filed: Aug. 7, 2025

(30) Foreign Application Priority Data
Aug. 9, 2024 (CN) 202411098815.8

(51) Int. Cl. B60L 50/61; B60K 1/00; B60K 17/02; B60K 17/08; F16H 37/08; F16H 63/32

(52) U.S. Cl. CPC B60L 50/61; B60K 17/02; B60K 17/08; F16H 37/082; F16H 63/32; B60K 2001/001; B60Y 2200/91

(57) ABSTRACT

A drive mechanism includes an internal combustion engine drive assembly drivingly connected to an internal combustion engine, a motor drive assembly drivingly connected to a motor, a wheel drive assembly drivingly connected to wheels, and a dog clutch, which includes a first engagement portion arranged on the internal combustion engine drive assembly, a second engagement portion arranged on the motor drive assembly, and a third engagement portion arranged on the wheel drive assembly, where the second engagement portion is axially movable to engage with the first engagement portion in a first axial position, disengage from the first engagement portion and the third engagement portion in a second axial position, and engage with the third engagement portion in a third axial position. The connection status of the drive assemblies is switched by the dog clutch to meet different drive requirements, and the switching is fast, efficient, and smooth.

### CROSS-REFERENCE TO RELATED APPLICATION

This application claims priority to Chinese Patent Application No. 202411098815.8 filed on Aug. 9, 2024, the entirety of which is hereby fully incorporated by reference herein.

### TECHNICAL FIELD

The present disclosure relates to the technical field of vehicles, and in particular to a hybrid electric system and a drive mechanism and a range extender thereof, and a vehicle including same.

### BACKGROUND

A power train of a pure electric vehicle is generally composed of three parts, namely, a driving motor, a controller, and a traction battery. Due to the limited power supply characteristics of the power train, pure electric vehicles usually face range anxiety when in use. To alleviate range anxiety, the automotive industry has introduced hybrid electric vehicles. A hybrid electric vehicle is a vehicle that is equipped with two power sources, namely a thermal power source (produced by a conventional gasoline or diesel engine) and an electric power source (a traction battery and a driving motor).

Among the hybrid electric vehicles, an extended-range electric vehicle has an internal combustion engine and a generator added to a pure electric vehicle. When the traction battery is low on power, the internal combustion engine acts as an energy compensation device to drive the generator to generate electricity so as to charge the traction battery and extend the range of the vehicle.

Current regulations require that the internal combustion engine in the extended-range electric vehicle can only be used to charge the traction battery, but not to provide driving power for the vehicle, that is, only the driving motor can provide the driving power to the vehicle when the vehicle is running. The current extended-range electric vehicle typically includes a driving motor, an internal combustion engine and a generator, where the internal combustion engine and the generator are used exclusively for generating electricity and are not involved in the driving of the vehicle. However, when the current extended-range electric vehicle is switched between a charging operation mode and an idle mode, there are problems such as slow response and incomplete decoupling of the internal combustion engine from the generator, and the user's driving experience is thus affected.

### SUMMARY

In view of the problems in the prior art, an objective of the present disclosure is to provide a hybrid electric system and a vehicle, to improve the response speed and smoothness of the switching of operation modes of an extended-range electric vehicle and improve the user's driving experience.

Embodiments of the present disclosure provide a hybrid electric system, including:
an internal combustion engine drive assembly configured to be drivingly connected to an internal combustion engine;
a motor drive assembly configured to be drivingly connected to a motor;
a wheel drive assembly configured to be drivingly connected to wheels; and
a dog clutch including a first engagement portion, a second engagement portion, and a third engagement portion, the first engagement portion being arranged on the internal combustion engine drive assembly, the second engagement portion being arranged on the motor drive assembly, and the third engagement portion being arranged on the wheel drive assembly, where the second engagement portion is axially movable to be engaged with the first engagement portion in a first axial position, disengaged from the first engagement portion and the third engagement portion in a second axial position, and engaged with the third engagement portion in a third axial position.

In some embodiments, the first engagement portion is provided with first engagement teeth at an end near the second engagement portion, the second engagement portion is provided with second engagement teeth at an end near the first engagement portion and third engagement teeth at an end near the third engagement portion, and the third engagement portion is provided with fourth engagement teeth at an end near the second engagement portion; and
the first engagement portion and the second engagement portion are engageable with each other by the first engagement teeth and the second engagement teeth, and the second engagement portion and the third engagement portion are engageable with each other by the third engagement teeth and the fourth engagement teeth.

In some embodiments, the first engagement portion includes external splines, the second engagement portion includes internal splines, and the third engagement portion includes external splines, the internal splines of the second engagement portion being engageable with the external splines of the first engagement portion in the first axial position, and engageable with the external splines of the third engagement portion in the third axial position.

In some embodiments, the motor drive assembly includes a second output shaft; and
the second engagement portion of the dog clutch is axially slidably sleeved outside the second output shaft and is rotationally fixedly connected to the second output shaft.

In some embodiments, the motor drive assembly further includes an input shaft, the input shaft being drivingly connected to the second output shaft via a reduction gear set.

In some embodiments, the reduction gear set includes a planetary gear mechanism.

In some embodiments, the internal combustion engine drive assembly includes a first output shaft, the first engagement portion is formed on or rotationally fixedly connected to the first output shaft, the second engagement portion is axially movably sleeved on the second output shaft by splines, and the third engagement portion is rotatably sleeved on the second output shaft by a bearing.

In some embodiments, the wheel drive assembly includes a gear rotatably sleeved on a second output shaft of the motor drive assembly, a differential, and axle shafts, the third engagement portion being drivingly connected to or integrally formed with the gear, the differential including a driven gear and differential side gears, the driven gear being drivingly connected to the gear, and the differential side gears being connected to the wheels via the axle shafts.

In some embodiments, the internal combustion engine drive assembly includes a torsional damper arranged between the internal combustion engine and the first engagement portion.

In some embodiments, a shift fork mechanism for the dog clutch is further included, the shift fork mechanism including a shift fork and a shift fork shaft, where a first end of the shift fork is fixedly connected to the shift fork shaft to move the shift fork with the shift fork shaft, a second end of the shift fork is connected to the second engagement portion, and the shift fork mechanism is capable of driving the second engagement portion to move in an axial direction of the second output shaft to bring the second engagement portion into any one of the first axial position, the second axial position, or the third axial position.

In some embodiments, a driving mechanism for driving the shift fork mechanism to move in a first direction is further included.

The embodiments of the present disclosure also provide a range extender for a hybrid electric system of a vehicle, the range extender including:
the drive mechanism as described above, and
a motor drivingly connected to the motor drive assembly of the drive mechanism.

The embodiments of the present disclosure also provide a hybrid electric system for a vehicle, the hybrid electric system including:
the range extender as described above, and
an internal combustion engine drivingly connected to the internal combustion engine drive assembly of the drive mechanism of the range extender,
where
the second engagement portion is engaged with the first engagement portion when the hybrid electric system is in a first operation mode;
the second engagement portion is not engaged with the first engagement portion or the third engagement portion when the hybrid electric system is in a second operation mode; and
the second engagement portion is engaged with the third engagement portion when the hybrid electric system is in a third operation mode. The embodiments of the present disclosure also provide a vehicle including the hybrid electric system as described above.

The hybrid electric system and the drive mechanism and the range extender thereof and the vehicle including same provided by the present disclosure have the following advantages.

When the second engagement portion and the first engagement portion of the dog clutch are engaged with each other, the internal combustion engine drive assembly is drivingly connected to the motor drive assembly, to cause the motor to generate electricity and thereby charge the battery, extending the range of the vehicle. When the second engagement portion and the third engagement portion of the dog clutch are connected to each other, the motor drive assembly is drivingly connected to the wheel drive assembly, and the motor in a power train drives the wheels to run, to effect travel of the vehicle. When the second engagement portion is engaged with neither of the first engagement portion and the third engagement portion of the dog clutch, the internal combustion engine drive assembly, the motor drive assembly and the wheel drive assembly are completely decoupled, the power train has no power output, and no electricity is generated. The drive connection status of the drive assemblies is switched by the engagement of the engagement portions of the dog clutch to meet different drive requirements, the switching response is fast, and the smoothness is high, thereby improving the user's driving experience.

Other features, objectives, and advantages of the present disclosure will become more apparent by reading the detailed description of non-limiting embodiments with reference to the following accompanying drawings.

### BRIEF DESCRIPTION OF THE DRAWINGS

FIG. 1 is a schematic view of a hybrid electric system according to one embodiment of the present disclosure;

FIG. 2 is a perspective view of a hybrid electric system according to one embodiment of the present disclosure;

FIG. 3 is a front view of a dog clutch according to one embodiment of the present disclosure; and

FIG. 4 is a top view of a dog clutch according to one embodiment of the present disclosure.

### DETAILED DESCRIPTION

Now exemplary implementations will be described more fully with reference to the accompanying drawings. However, the exemplary implementations can be implemented in many forms and should not be construed as being limited to the implementations set forth herein. On the contrary, these implementations are provided to make the disclosure thorough and complete, and to fully convey the concept of the exemplary implementations to those skilled in the art. In the drawings, the same reference signs denote the same or similar structures, and thus the repeated description thereof will be omitted. The term “or” in the specification may mean “and” or “or.”

In the description of the present application, the description referring to the terms “an embodiment,” “some embodiments,” “an example,” “a specific example,” or “some examples” means that a specific feature, structure, material or characteristic described with reference to the embodiment or example is included in at least one embodiment or example of the present application. Moreover, the specific feature, structure, material, or characteristic described may be combined in any suitable manner in any one or more embodiments or examples. In addition, without mutual contradiction, those skilled in the art may incorporate and combine different embodiments or examples and features of the different embodiments or examples described in the present application.

In addition, the terms “first” and “second” are used for descriptive purposes only, and cannot be construed as indicating or implying relative importance or implicitly indicating the number of technical features indicated. Therefore, the features defined with “first” and “second” may explicitly or implicitly comprise at least one of the features. In the description of the present application, the meaning of “a plurality of” is two or more, unless explicitly and specifically defined otherwise.

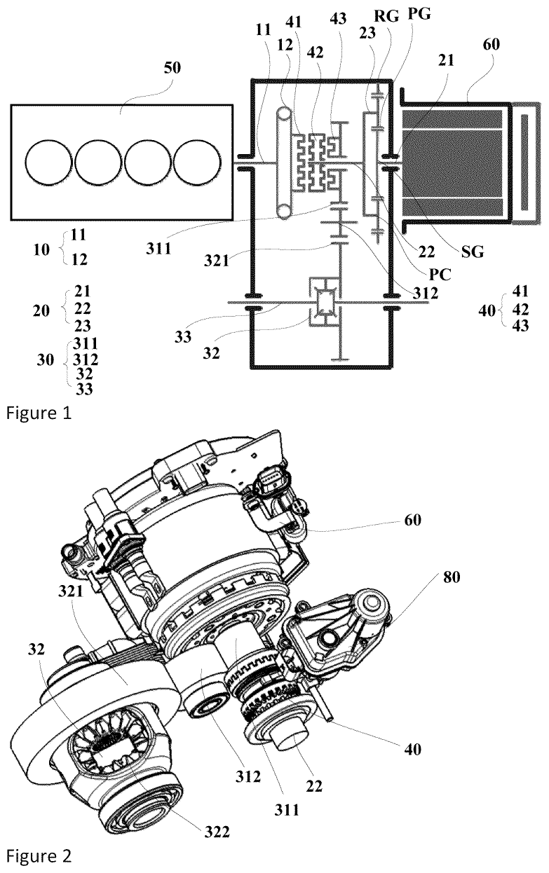

In order to solve the problems in the prior art, the embodiments of the present disclosure provide a drive mechanism of a hybrid electric system for a vehicle. As shown in FIGS. 1 to 4, the drive mechanism includes an internal combustion engine drive assembly 10, a motor drive assembly 20, a wheel drive assembly 30, and a dog clutch 40. The internal combustion engine drive assembly 10 is configured to be drivingly connected to an internal combustion engine 50, the motor drive assembly 20 is configured to be drivingly connected to a motor 60, and the wheel drive assembly 30 is configured to be drivingly connected to wheels. The dog clutch 40 includes a first engagement portion 41, a second engagement portion 42, and a third engagement portion 43. The first engagement portion 41 is arranged on the internal combustion engine drive assembly 10, and the second engagement portion 42 is arranged on the motor drive assembly 20. The second engagement portion 42 can be axially moved to be engaged with the first engagement portion 41 in a first axial position, disengaged from the first engagement portion 41 and the third engagement portion 43 in a second axial position, and engaged with the third engagement portion 43 in a third axial position.

When the second engagement portion 42 is engaged with the first engagement portion 41, the internal combustion engine drive assembly 10 is drivingly connected to the motor drive assembly 20, and the internal combustion engine 50 can transmit torque to the motor 60 through the internal combustion engine drive assembly 10, to enable the motor 60 to generate electricity and thereby charge a battery. When the second engagement portion 42 is engaged with the third engagement portion 43, the motor drive assembly 20 is drivingly connected to the wheel drive assembly 30, and the output torque of the motor is transmitted to the wheels through the wheel drive assembly 30 to drive the vehicle to travel. When the second engagement portion is disengaged from the first engagement portion 41 and the third engagement portion 43, the internal combustion engine drive assembly 10, the motor drive assembly 20, and the wheel drive assembly 30 are completely decoupled, the drive mechanism has no torque output, and no electricity is generated. The drive connection status of the drive assemblies can be switched by the dog clutch to meet different drive requirements of the drive mechanism, the switching response is fast, the switching efficiency is high, and the switching is smooth, so that the user's driving experience can be improved.

With continued reference to FIGS. 1 to 4, the first engagement portion 41 is provided with first engagement teeth at an end near the second engagement portion 42, the second engagement portion 42 is provided with second engagement teeth at an end near the first engagement portion 41, the second engagement portion 42 is provided with third engagement teeth at an end near the third engagement portion, and the third engagement portion 43 is provided with fourth engagement teeth at an end near the second engagement portion. That is, the first engagement portion 41 and the third engagement portion 43 are each provided with one-sided engagement teeth, and the second engagement portion 42 is provided with two-sided engagement teeth.

The first engagement portion 41 and the second engagement portion 42 are engaged with each other by the first engagement teeth and the second engagement teeth, and the second engagement portion 42 and the third engagement portion 43 are engaged with each other by the third engagement teeth and the fourth engagement teeth.

The dog clutch 40 is free from frictional sticking during disengagement and engagement, and has high drive efficiency, fast response, rapid and smooth engagement and disengagement, and flexible mode switching, thereby improving the smoothness and flexibility of the vehicle and improving the user's driving experience.

In another embodiment, it is also possible to provide that the first engagement portion 41 includes external splines, the second engagement portion 42 includes internal splines, and the third engagement portion 43 includes external splines, the internal splines of the second engagement portion 42 being engageable with the external splines of the first engagement portion 41 in the first axial position, and engageable with the external splines of the third engagement portion 43 in the third axial position.

Further, the motor drive assembly 20 includes a second output shaft 22, and the second engagement portion 42 of the dog clutch 40 is axially slidably sleeved outside the second output shaft 22 and is rotationally fixedly connected to the second output shaft 22. When the motor 60 outputs torque through the motor drive assembly 20, the second engagement portion 42 rotates with the second output shaft 22, thereby outputting torque.

Further, the motor drive assembly 20 includes an input shaft 21, the input shaft 21 being drivingly connected to the second output shaft 22 via a reduction gear set. The reduction gear set is used to reduce the rotational speed of the motor 60 and increase the output torque. In some cases, the motor drive assembly 20 may include only the second output shaft 22 directly connected to the motor, without including the reduction gear set.

The reduction gear set in the embodiments of the present disclosure includes a planetary gear mechanism 23. The planetary gear mechanism 23 includes a sun gear SG, a ring gear RG arranged coaxially around the sun gear SG, and planetary gears PG engaged between the sun gear SG and the ring gear RG. The center of each planetary gear PG is connected to a planetary carrier PC. The input shaft 21 is connected to the center of the sun gear SG. The second output shaft 22 is coaxially connected to the planetary carrier PC. In this embodiment, during specific operation of the planetary gear mechanism, the ring gear RG is fixed, the sun gear SG rotates to drive the planetary gears PG to rotate and then drive the planetary gear PG to rotate the planetary carrier PC, and the planetary carrier PC in turn drives the second output shaft 22 to rotate. Similarly, when the ring gear RG is fixed and the second output shaft 22 rotates, the input shaft 21 will rotate correspondingly through the transmission of the planetary carrier PC, the planetary gears PG, and the sun gear SG.

However, the motor drive assembly 20 is not limited to include only one planetary gear mechanism. In other embodiments, the motor drive assembly may include a multi-gear drive mechanism composed of a plurality of planetary gear mechanisms, with different members of the planetary gear mechanisms being engaged to form different drive ratios. The multi-gear drive mechanism can improve the gear shift smoothness and increase the drive efficiency.

Further, the internal combustion engine drive assembly 10 includes a first output shaft 11, and a first engagement portion 41 is formed on the first output shaft 11 or is rotationally fixedly connected to the first output shaft 11; and the second engagement portion 42 is axially movably sleeved on the second output shaft 22 by splines, and the third engagement portion 43 is rotatably sleeved on the second output shaft 22 by a bearing. When the first output shaft 11 rotates, the first engagement portion 41 rotates with the first output shaft 11. The second engagement portion 42 may be axially movably sleeved on the second output shaft 22 by splines, so that the second engagement portion 42 can rotate with the second output shaft 22, and can move in an axial direction of the second output shaft 22 to engage with or disengage from the first engagement portion 41 or the third engagement portion 43. Due to the presence of the bearing, when the second output shaft 22 rotates, the third engagement portion 43 does not rotate with the second output shaft 22.

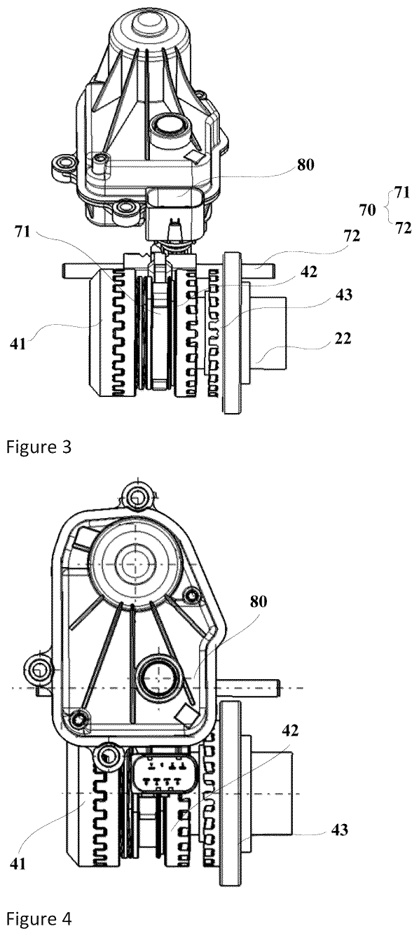

Referring to FIG. 3, the drive mechanism further includes a shift fork mechanism 70 for the dog clutch 40. The shift fork mechanism includes a shift fork 71 and a shift fork shaft 72. A first end of the shift fork 71 is fixedly connected to the shift fork shaft 72 such that the shift fork 71 moves with the shift fork shaft 72, a second end of the shift fork 71 is connected to the second engagement portion 42, and the shift fork mechanism 70 can drive the second engagement portion 42 to move in the axial direction of the second output shaft 22 to bring the second engagement portion 42 into any one of the first axial position, the second axial position, or the third axial position to meet different drive requirements.

Further, the drive mechanism further includes a driving mechanism 80, the driving mechanism 80 driving the shift fork mechanism 70 to move in a first direction. The first direction here is the left-right direction as seen on the paper. As shown in FIG. 3, the shift fork mechanism 70 is now in the first axial position to engage the first engagement portion 41 with the second engagement portion 42. The third engagement portion 43 is engaged with the second engagement portion 42 when the shift fork mechanism is moved to the right to the third axial position. The second engagement portion 42 is disengaged from the first engagement portion 41 and the third engagement portion 43 when the shift fork mechanism is moved to the right to the second axial position.

Further, with continued reference to FIGS. 1 and 2, the wheel drive assembly 30 includes a gear 311 rotatably sleeved on the second output shaft 22 of the motor drive assembly 20, a differential 32, and axle shafts 33. The third engagement portion 43 is drivingly connected to the gear 311 or is integrally formed with the gear 311, and the differential 32 includes a driven gear 321 and differential side gears 322. The driven gear 321 is drivingly connected to the gear 311 (in the illustrated embodiment, via an idler gear 312), and the differential side gears 322 are connected to the wheels via the axle shafts 33. The differential 32 allows the axle shafts 33 to rotate at different rotational speeds, ensuring power transmission under various movement conditions and preventing the wheels from slipping on the road surface.

As shown in FIGS. 1 and 2, in this embodiment, the wheel drive assembly 30 further includes an idler gear 312 configured as an idler gear. The idler gear 312 is engaged with the gear 311 and the driven gear 321 of the differential 32. When the second output shaft 22 rotates, the second engagement portion 42 is driven to rotate. When the third engagement portion 43 is engaged with the second engagement portion 42, the third engagement portion 43 and the gear 311 are correspondingly driven to rotate, the gear 311 transmits torque further to the idler gear 312, the idler gear 312 transmits the torque through the driven gear 321 to the differential side gears 322, and the differential side gears 322 output the torque through the axle shafts 33 to the wheels to drive the wheels to run, thereby achieving the motor-driven travel of the vehicle.

As shown in FIG. 1, in some embodiments, the internal combustion engine drive assembly 10 further includes a torsional damper 12. The torsional damper 12 is arranged between the internal combustion engine 50 and the first engagement portion 41, to provide a cushioning and damping function, thereby reducing the vibration of the internal combustion engine 50 during power transmission and ensuring the stability of power transmission.

The embodiments of the present disclosure also provide a range extender of a hybrid electric system for a vehicle, the range extender including the drive mechanism as described above and a motor 60, the motor 60 being drivingly connected to the motor drive assembly 20. The electricity generated by the range extender can charge the battery and provide additional power to extend the range of the electric vehicle.

Further, the embodiments of the present disclosure also provide a hybrid electric system for a vehicle, the hybrid electric system including the range extender as described above and an internal combustion engine 50, the internal combustion engine 50 being drivingly connected to the internal combustion engine drive assembly 10 of the drive mechanism of the range extender.

The second engagement portion 42 is engaged with the first engagement portion 41 when the hybrid electric system is in a first operation mode.

The second engagement portion 42 is not engaged with the first engagement portion 41 or the third engagement portion 43 when the hybrid electric system is in a second operation mode.

The second engagement portion 42 is engaged with the third engagement portion 43 when the hybrid electric system is in a third operation mode.

Based on the above description of the components of the hybrid electric system, the operation modes of the hybrid electric system will be described below.

The first operation mode here is a power generation operation mode. Specifically, when the first operation mode is executed, the internal combustion engine 50 is first started, the first output shaft 11 of the internal combustion engine drive assembly 10 is rotated under the action of the internal combustion engine 50, and the first engagement portion 41 is then driven to rotate; when the second engagement portion 42 moves in the direction of the first engagement portion 41 and is engaged with the first engagement portion 41, the first engagement portion 41 drives the second engagement portion 42 to rotate, and the second engagement portion 42 drives the second output shaft 22 of the motor drive assembly 20 to rotate; and the output torque of the second output shaft 22 is transmitted to a rotating shaft of the motor 60 through the transmission of the reduction gear set, and the rotating shaft is rotated so that the motor 60 can act as a generator to charge the battery, increasing the storage capacity of the battery.

The second operation mode here is a decoupled operation mode, i.e. the hybrid electric system does not perform charging and does not drive the wheels of the vehicle to run by the motor. Specifically, when the second operation mode is executed, the second engagement portion 42 is engaged with neither of the first engagement portion 41 and the second engagement portion 42, in which case the internal combustion engine drive assembly 10, the motor drive assembly 20 and the wheel drive assembly 30 are completely decoupled.

The third operation mode here is a pure electric driving mode. Specifically, when the third operation mode is executed, the second engagement portion 42 is engaged with the third engagement portion 43, and the motor 60 transmits torque to the input shaft 21 of the motor drive assembly 20 through the transmission of the rotating shaft, the torque is transmitted to the second output shaft 22 after being decelerated by the reduction gear set, the second engagement portion 42 rotates with the second output shaft 22 and thus drives the third engagement portion 43 to rotate, and the torque of the third engagement portion 43 is further transmitted to the differential 32 through the gear 311 and the idler gear 312, and is further decelerated by the differential 32, and the differential 32 then outputs power to the wheels through the axle shafts 33 to drive the rotation and travel of the wheels of the vehicle.

By controlling the connection status of the engagement portions of the dog clutch 40 in different states such that the hybrid electric system is in different operation modes, the dog clutch 40 is free from frictional sticking during disengagement and engagement, and has high drive efficiency, fast response, rapid and smooth engagement and disengagement, and flexible mode switching, thereby improving the smoothness and flexibility of the vehicle and improving the user's driving experience.

The embodiments of the present disclosure also provide a vehicle including the hybrid electric system as described above. All the technical effects of the hybrid electric system as described above can be achieved by the vehicle according to the embodiments of the present disclosure and will not be described here again.

Further, the range extender or vehicle including the drive mechanism as described above is provided with a controller for controlling the driving mechanism 80 to move the second engagement portion 42 in the axial direction of the second output shaft 22 in different drive demand modes to effect the drive connection of different drive assemblies.

In summary, the hybrid electric system and the drive mechanism and the range extender thereof and the vehicle including same provided by the present disclosure have the following advantages.

When the second engagement portion and the first engagement portion are engaged with each other, the internal combustion engine drive assembly is drivingly connected to the motor drive assembly, to cause the motor to generate electricity as a generator and thereby charge the battery, extending the range of the vehicle. When the second engagement portion is engaged with the third engagement portion, the motor drive assembly is drivingly connected to the wheel drive assembly to drive the wheels to rotate, to effect travel of the vehicle. When the second engagement portion is disengaged from the first engagement portion and the third engagement portion, the hybrid electric system has no power output, and no electricity is generated. In the present disclosure, the drive connection status of the internal combustion engine drive assembly, the motor drive assembly and the wheel drive assembly is switched by the dog clutch, providing the advantages of high drive efficiency, fast response, rapid and smooth engagement and disengagement, and high smoothness, thereby improving the user's driving experience.

The above is a further detailed description of the present disclosure with reference to the specific preferred implementations, and it cannot be considered that the specific implementation of the present disclosure is limited to these descriptions. For those of ordinary skill in the art of the present disclosure, several simple deductions or substitutions can be further made without departing from the concept of the present disclosure, and should be regarded as falling within the scope of protection of the present disclosure.

List of reference signs:
Internal combustion engine drive

| | | | |
|---|---|---|---|
| 10 | assembly | 32 | Differential |
| 11 | First output shaft | 321 | Driven gear |
| 12 | Torsional damper | 33 | Axle shaft |
| 20 | Motor drive assembly | 322 | Differential side gear |
| 21 | Input shaft | 40 | Dog clutch |
| 22 | Second output shaft | 41 | First engagement portion |
| | | | Second engagement |
| 23 | Planetary reduction mechanism | 42 | portion |
| | | | Third engagement |
| RG | Ring gear | 43 | portion |
| SG | Sun gear | 44 | Shift fork |
| | | | Internal combustion |
| PG | Planetary gear | 50 | engine |
| PC | Planetary carrier | 60 | Motor |
| 30 | Wheel drive assembly | 70 | Shift fork mechanism |
| 311 | Gear | 71 | Shift fork |
| 312 | Idler gear | 72 | Shift fork shaft |
| | | 80 | Driving mechanism |

1. A drive mechanism of a hybrid electric system for a vehicle, the drive mechanism comprising:
an internal combustion engine drive assembly configured to be drivingly connected to an internal combustion engine;
a motor drive assembly configured to be drivingly connected to a motor;
a wheel drive assembly configured to be drivingly connected to one or more wheels; and
a dog clutch comprising a first engagement portion, a second engagement portion, and a third engagement portion, the first engagement portion being arranged on the internal combustion engine drive assembly, the second engagement portion being arranged on the motor drive assembly, and the third engagement portion being arranged on the wheel drive assembly,
wherein the second engagement portion is configured to be axially movable to be engaged with the first engagement portion in a first axial position, disengaged from the first engagement portion and the third engagement portion in a second axial position, and engaged with the third engagement portion in a third axial position.

2. The drive mechanism according to claim 1,
wherein the first engagement portion comprises first engagement teeth at an end of the first engagement portion near the second engagement portion,
wherein the second engagement portion comprises second engagement teeth at a first end of the second engagement portion near the first engagement portion and third engagement teeth at a second end of the second engagement portion near the third engagement portion,
wherein the third engagement portion comprises fourth engagement teeth at an end of the third engagement portion near the second engagement portion,
wherein the first engagement portion and the second engagement portion are configured to engage with each other via the first engagement teeth and the second engagement teeth, and
wherein the second engagement portion and the third engagement portion are configured to engage with each other via the third engagement teeth and the fourth engagement teeth.

3. The drive mechanism according to claim 2,
wherein the motor drive assembly comprises a second output shaft, and
wherein the second engagement portion of the dog clutch is axially slidably sleeved outside the second output shaft and is rotationally fixedly connected to the second output shaft.

4. The drive mechanism according to claim 3,
wherein the motor drive assembly comprises an input shaft, wherein the input shaft is drivingly connected to the second output shaft via a reduction gear set.

5. The drive mechanism according to claim 4,
wherein the reduction gear set comprises a planetary gear mechanism.

6. The drive mechanism according to claim 3,
wherein the internal combustion engine drive assembly comprises a first output shaft,
wherein the first engagement portion is formed on or rotationally fixedly connected to the first output shaft,
wherein the second engagement portion is axially movably sleeved on the second output shaft via one or more splines, and
wherein the third engagement portion is rotatably sleeved on the second output shaft via a bearing.

7. The drive mechanism according to claim 3, comprising:
a shift fork mechanism for the dog clutch, the shift fork mechanism comprising a shift fork and a shift fork shaft,
wherein a first end of the shift fork is fixedly connected to the shift fork shaft to move the shift fork with the shift fork shaft,
wherein a second end of the shift fork is connected to the second engagement portion, and
wherein the shift fork mechanism is configured to drive the second engagement portion to move in an axial direction of the second output shaft to bring the second engagement portion into any one of the first axial position, the second axial position, or the third axial position.

8. The drive mechanism according to claim 7, comprising:
a driving mechanism configured to drive the shift fork mechanism to move in a first direction.

9. The drive mechanism according to claim 1,
wherein the first engagement portion comprises external splines,
wherein the second engagement portion comprises internal splines, and
wherein the third engagement portion comprises external splines,
wherein the internal splines of the second engagement portion are configured to engage with the external splines of the first engagement portion in the first axial position, and engage with the external splines of the third engagement portion in the third axial position.

10. The drive mechanism according to claim 9,
wherein the motor drive assembly comprises a second output shaft, and
wherein the second engagement portion of the dog clutch is axially slidably sleeved outside the second output shaft and is rotationally fixedly connected to the second output shaft.

11. The drive mechanism according to claim 10,
wherein the motor drive assembly comprises an input shaft, wherein the input shaft is drivingly connected to the second output shaft via a reduction gear set.

12. The drive mechanism according to claim 11,
wherein the reduction gear set comprises a planetary gear mechanism.

13. The drive mechanism according to claim 10,
wherein the internal combustion engine drive assembly comprises a first output shaft,
wherein the first engagement portion is formed on or rotationally fixedly connected to the first output shaft,
wherein the second engagement portion is axially movably sleeved on the second output shaft via one or more splines, and
wherein the third engagement portion is rotatably sleeved on the second output shaft via a bearing.

14. The drive mechanism according to claim 10, comprising:
a shift fork mechanism for the dog clutch, the shift fork mechanism comprising a shift fork and a shift fork shaft,
wherein a first end of the shift fork is fixedly connected to the shift fork shaft to move the shift fork with the shift fork shaft,
wherein a second end of the shift fork is connected to the second engagement portion, and
wherein the shift fork mechanism is configured to drive the second engagement portion to move in an axial direction of the second output shaft to bring the second engagement portion into any one of the first axial position, the second axial position, or the third axial position.

15. The drive mechanism according to claim 14, comprising:
a driving mechanism configured to drive the shift fork mechanism to move in a first direction.

16. The drive mechanism according to claim 1,
wherein the wheel drive assembly comprises:
a gear rotatably sleeved on a second output shaft of the motor drive assembly;
a differential; and
axle shafts,
wherein the third engagement portion is drivingly connected to or integrally formed with the gear, and
wherein the differential comprises a driven gear and differential side gears, the driven gear being drivingly connected to the gear, and the differential side gears being connected to the one or more wheels via the axle shafts.

17. The drive mechanism according to claim 1,
wherein the internal combustion engine drive assembly comprises a torsional damper arranged between the internal combustion engine and the first engagement portion.

18. A range extender of a hybrid electric system for a vehicle, the range extender comprising:
the drive mechanism of claim 1; and
a motor drivingly connected to the motor drive assembly of the drive mechanism.

19. A hybrid electric system for a vehicle, the hybrid electric system comprising:
a range extender of claim 18; and
an internal combustion engine drivingly connected to the internal combustion engine drive assembly of the drive mechanism of the range extender,
wherein the second engagement portion is engaged with the first engagement portion when the hybrid electric system is in a first operation mode,
wherein the second engagement portion is not engaged with the first engagement portion or the third engagement portion when the hybrid electric system is in a second operation mode, and
wherein the second engagement portion is engaged with the third engagement portion when the hybrid electric system is in a third operation mode.

20. A vehicle, comprising a hybrid electric system of claim 19.
